(19) United States
(12) Patent Application Publication
(10) Pub. No.: US 2023/0244932 A1
(43) Pub. Date: Aug. 3, 2023

(54) IMAGE OCCLUSION METHOD, MODEL TRAINING METHOD, DEVICE, AND STORAGE MEDIUM

(71) Applicant: Beijing Baidu Netcom Science Technology Co., Ltd., Beijing (CN)

(72) Inventors: Ji LIU, Beijing (CN); Qilong LI, Beijing (CN); Yu LI, Beijing (CN); Xingjian LI, Beijing (CN); Yifan SUN, Beijing (CN); Dejing DOU, Beijing (CN)

(21) Appl. No.: 18/076,501

(22) Filed: Dec. 7, 2022

(30) Foreign Application Priority Data
Jan. 29, 2022 (CN) 202210112797.9

(51) Int. Cl. G06N 3/08; G06V 10/82

(52) U.S. Cl. CPC G06N 3/08; G06V 10/82

(57) ABSTRACT

Provided are an image occlusion method, a model training method, a device, and a storage medium, which relate to the technical field of artificial intelligence, in particular, to the field of computer vision technologies and deep learning, and may be applied to image recognition, model training and other scenarios. The specific implementation solution is as follows: generating a candidate occlusion region according to an occlusion parameter; according to the candidate occlusion region, occluding an image to be processed to obtain a candidate occlusion image; determining a target occlusion region from the candidate occlusion region according to visual security and data availability of the candidate occlusion image; and according to the target occlusion region, occluding the image to be processed to obtain a target occlusion image. In this manner, the image to be processed is desensitized while the accuracy of target recognition is ensured.

### CROSS-REFERENCE TO RELATED APPLICATION(S)

This application claims priority from Chinese Patent Application No. 202210112797.9 filed Jan. 29, 2022, the disclosure of which is incorporated herein by reference in its entirety.

### TECHNICAL FIELD

The present disclosure relates to the technical field of artificial intelligence, in particular, to the field of computer vision technologies and deep learning, and may be applied to image recognition, model training and other scenarios.

### BACKGROUND

In recent years, with the development of deep learning technology, target recognition technology based on deep learning (such as face recognition technology) has also entered a new climax of development. However, an image to be recognized required by the target recognition technology based on deep learning may involve sensitive information. For example, when a face recognition model is trained based on the face recognition technology, the used face image contains a lot of sensitive information. Therefore, how to desensitize an image to be processed (such as occlusion processing) while ensuring the accuracy of target recognition is an urgent problem to be solved.

### SUMMARY

The present disclosure provides an image occlusion method and apparatus, a model training method and apparatus, a device, and a storage medium.

According to an aspect of the present disclosure, an image occlusion method is provided. The method includes steps described below.

A candidate occlusion region is generated according to an occlusion parameter.

According to the candidate occlusion region, an image to be processed is occluded so as to obtain a candidate occlusion image.

A target occlusion region is determined from the candidate occlusion region according to visual security and data availability of the candidate occlusion image.

According to the target occlusion region, the image to be processed is occluded so as to obtain a target occlusion image.

According to another aspect of the present disclosure, a model training method is provided. The method includes steps described below.

A target occlusion image and a target occlusion region are acquired; where the target occlusion image and the target occlusion region are obtained by using the image occlusion method according to any embodiment of the present disclosure.

A target recognition model is trained according to the target occlusion image, the target occlusion region and an actual recognition result of the target occlusion image.

According to another aspect of the present disclosure, an electronic device is provided. The electronic device includes at least one processor and a memory communicatively connected to the at least one processor.

The memory stores instructions executable by the at least one processor, and the instructions are executed by the at least one processor to cause the at least one processor to perform the image occlusion method and/or model training method according to any embodiment of the present disclosure.

According to another aspect of the present disclosure, a non-transitory computer-readable storage medium is provided. The storage medium stores computer instructions for causing a computer to perform the image occlusion method and/or model training method according to any embodiment of the present disclosure.

The solution of embodiments of the present disclosure provides a preferred solution for occluding an image and training a model based on the generated occlusion image. In this manner, the security and availability of the occluded image can be improved, and further, when the model is trained based on the occlusion image, not only is the leakage of sensitive information avoided, but also the accuracy of model training is ensured.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1A is a flowchart of an image occlusion method according to an embodiment of the present disclosure;

FIG. 1B is an image occlusion effect view according to an embodiment of the present disclosure;

FIG. 2 is a flowchart of an image occlusion method according to an embodiment of the present disclosure;

FIG. 3 is a flowchart of an image occlusion method according to an embodiment of the present disclosure;

FIG. 4 is a schematic diagram of a principle for determining a target occlusion region according to an embodiment of the present disclosure;

FIG. 5 is a flowchart of a model training method according to an embodiment of the present disclosure;

FIG. 6 is a schematic diagram of a target recognition model according to an embodiment of the present disclosure;

FIG. 7 is a flowchart of a model training method according to an embodiment of the present disclosure;

FIG. 8 is a structural diagram of an image occlusion apparatus according to an embodiment of the present disclosure;

FIG. 9 is a structural diagram of a model training apparatus according to an embodiment of the present disclosure; and

FIG. 10 is a block diagram of an electronic device for performing an image occlusion method and/or model training method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be appreciated by those of ordinary skill in the art that various changes and modifications may be made to the embodiments herein without departing from the scope and spirit of the present disclosure. Similarly, description of well-known functions and constructions is omitted hereinafter for clarity and conciseness.

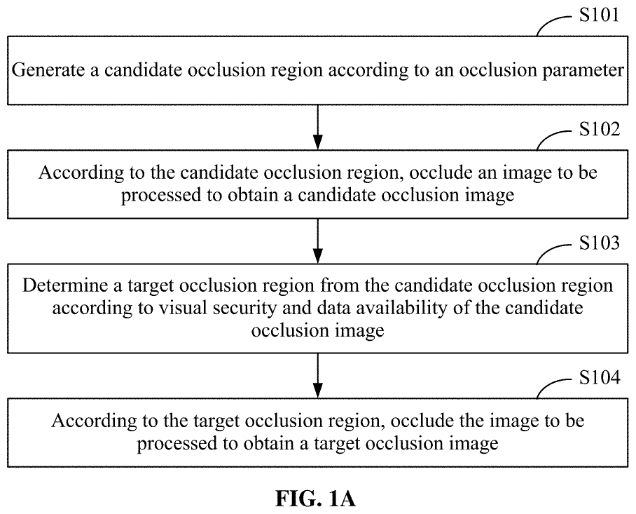

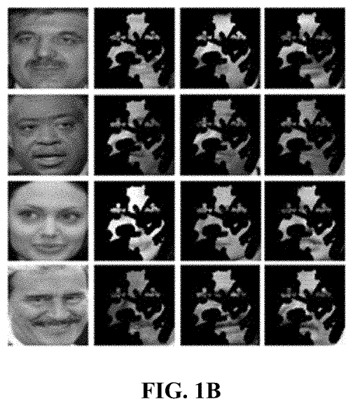

FIG. 1A is a flowchart of an image occlusion method according to an embodiment of the present disclosure; and FIG. 1B is an image occlusion effect view according to an embodiment of the present disclosure. The embodiment of the present disclosure is applicable to the case of performing regional occlusion on an image. It is especially applicable to the case of performing regional occlusion on an image containing sensitive information (such as a face image). The method may be performed by an image occlusion apparatus. The apparatus may be implemented by means of software and/or hardware. As shown in FIGS. 1A and 1B, the image occlusion method provided by this embodiment may include steps described below.

In S101, a candidate occlusion region is generated according to an occlusion parameter.

The occlusion parameter may be a parameter required for regional occlusion, for example, including but not limited to: a dimension of a canvas to be occluded (that is, a dimension of an image to be processed), a number of occlusion vertices, an occlusion length, an occlusion width, and an occlusion angle. The candidate occlusion region may be a regional image obtained by adding at least one occlusion of any shape to the canvas to be occluded based on the occlusion parameter. The candidate occlusion region drawn on the canvas may be a binarized regional image, a gray value of an occluded part may be 1, and a gray value of an un-occluded part may be 0. Moreover, the dimension of the canvas on which the candidate occlusion region is drawn is the same as the dimension of the image to be processed. Preferably, occlusion positions and/or occlusion shapes contained in different candidate occlusion regions are different. Preferably, multiple candidate occlusion regions exist in this embodiment.

Optionally, in this embodiment, a possible implementation manner of generating the candidate occlusion region according to the occlusion parameter is as follows: based on the preset occlusion parameter, calling an occlusion generation algorithm (Generate Mask) to randomly generate a variety of different occlusion shapes, and randomly drawing these occlusion shapes on different positions on the canvas to obtain one candidate occlusion region. Another possible implementation manner is as follows: inputting the occlusion parameter into a pre-trained occlusion generation model, and based on the inputted occlusion parameter, randomly adding, by the model, an occlusion on the canvas to obtain the candidate occlusion region.

In S102, according to the candidate occlusion region, an image to be processed is occluded so as to obtain a candidate occlusion image.

The image to be processed may be an image that needs to be occluded. Preferably, the image to be processed may be an image that contains sensitive information and on which data desensitization needs to be performed by occlusion, such as the face image.

Optionally, in this embodiment, for each candidate occlusion region generated in S101, the image to be processed is occluded based on the candidate occlusion region, so as to obtain the candidate occlusion image corresponding to the candidate occlusion region. That is, for each candidate occlusion region, one candidate occlusion image is correspondingly obtained.

Specifically, since the dimension of the canvas on which the candidate occlusion region is drawn is the same as the dimension of the image to be processed, a possible implementation manner is as follows: summing a gray value of each position point in the canvas where the candidate occlusion region is located and a gray value of a corresponding position point in the image to be processed as a gray value of each position point in the candidate occlusion image to obtain the candidate occlusion image; and another possible implementation manner is as follows: acquiring the corresponding shape and position of the candidate occlusion region in the canvas, finding the position in the image to be processed, and occluding image content by the shape to obtain the candidate occlusion image.

In S103, a target occlusion region is determined from the candidate occlusion region according to visual security and data availability of the candidate occlusion image.

The visual security may be an indicator to measure how much sensitive information is reflected directly by the occluded image or after image restoration. Specifically, if the occluded image directly reflects or indirectly reflects more sensitive information through an image restoration algorithm, it means that it is easier to identify sensitive information in the occluded image, that is, the visual security is lower. The data availability may be an indicator to measure the availability of the occluded image. Specifically, if scenarios (such as model training, target recognition, and target tracking) in which the occluded image can be used instead of the un-occluded image are wider, the data availability of the occluded image is higher. The target occlusion region may refer to an occlusion region that needs to be used for occluding the image to be processed and is selected from the candidate occlusion regions. Optionally, one or more target occlusion regions may exist.

Optionally, in this embodiment, when the target occlusion region is determined from the candidate occlusion regions according to the visual security and the data availability of the candidate occlusion images, the candidate occlusion region corresponding to the candidate occlusion image with relatively high visual security and data availability may be selected from the candidate occlusion images as the target occlusion region. Specifically, a possible implementation manner is as follows: setting corresponding thresholds for the visual security and the data availability, such as a security threshold and an availability threshold, and selecting the candidate occlusion region corresponding to the candidate occlusion image with the visual security higher than the security threshold and the data availability higher than the availability threshold from the candidate occlusion images as the target occlusion region. Another possible implementation manner is as follows: inputting the two indicators of the visual security and the data availability of each candidate occlusion image, and the candidate occlusion images into a pre-trained indicator analysis model, analyzing, by the model, the inputted data to give at least one candidate occlusion image with a better effect, and at this time, using the candidate occlusion region corresponding to the at least one candidate occlusion image with the better effect as the target occlusion region.

Optionally, in this embodiment, multiple methods for determining the visual security and the data availability of the candidate occlusion image exist, which are not limited in this embodiment. For example, a trained neural network model is used for prediction. The visual security and the data availability of the candidate occlusion image may also be determined by a preset algorithm. Specifically, when the visual security of the candidate occlusion image is determined, the higher the structural similarity (SSIM) between the candidate occlusion image and the corresponding image to be occluded (that is, an original image of the candidate occlusion image) is, the lower the visual security is. When the data availability of the candidate occlusion image is determined, the candidate occlusion image and the corresponding image to be occluded may be used in a variety of different scenarios, and errors of use effects are determined, where the smaller the errors are, the higher the data availability is.

In S104, according to the target occlusion region, the image to be processed is occluded so as to obtain a target occlusion image.

Optionally, in this embodiment, a method similar to S102 may be adopted, and based on the target occlusion region determined in S103, the image to be processed is occluded so as to obtain the target occlusion image. Repetitions are not made here.

By way of example, in FIG. 1B, the same row represents different face images of a person, where the first image of each row is an un-occluded face image, and the latter three are effect views after occlusion is performed by using the same target occlusion region. It can be seen from FIG. 1B that the occluded image in this solution has relatively high visual security and hardly leaks the face of the user.

According to the solution of the embodiment of the present disclosure, candidate occlusion regions are randomly generated according to the occlusion parameter, the target occlusion region is determined from the candidate occlusion regions according to effects after the image to be processed is occluded by the candidate occlusion regions, that is, the visual security and the data availability, and then the image to be processed is occluded based on the target occlusion region so as to obtain the target occlusion image. In the solution in this embodiment, regional occlusion is performed on the image from the perspective of the visual security and the data availability. Compared with the related art in which specific regions (such as human eyes, nose or mouth) are occluded, in this embodiment, not only is the availability of the occluded image taken into account, but also a desensitization effect of sensitive information in the original image is greatly improved and the flexibility of the occluded region is improved. A new solution for the occlusion of sensitive information in the image is provided.

Optionally, in the embodiment of the present disclosure, another possible implementation manner of determining the visual security and the data availability of the candidate occlusion image is as follows: determining repairability and an occlusion ratio of the candidate occlusion image according to the candidate occlusion image and the image to be processed and determining the visual security of the candidate occlusion image according to the repairability and the occlusion ratio; and determining the data availability of the candidate occlusion image according to a target recognition result of the candidate occlusion image and a target recognition result of the image to be processed.

The repairability may be a performance indicator to measure whether the occluded image is easy to be restored to the original image (that is, the image to be processed). Specifically, when the visual security of the candidate occlusion image is determined, an image repair algorithm may be called to repair the candidate occlusion image, and then the similarity between the repaired image and the original image (that is, the image to be processed) is calculated as repairability of the candidate occlusion image. A ratio of the occlusion region to a total image region in the candidate occlusion image is calculated as the occlusion ratio. The higher the repairability of the candidate occlusion image is, the lower the visual security is; and the higher the occlusion ratio is, the higher the visual security is. Therefore, in this embodiment, a difference (or a weighted difference) between the occlusion ratio of the candidate occlusion image and the repairability is calculated as the visual security of the candidate occlusion image, or the occlusion ratio and the repairability may be directly used as values of the visual security in two dimensions.

When the data availability of the candidate occlusion image is determined, a target recognition algorithm corresponding to the image to be processed may be called (if the image to be processed is the face image, a face recognition algorithm is called) to perform target recognition processing on the candidate occlusion image and the image to be processed, and errors of two target recognition results are determined, where the smaller the errors are, the higher the data availability of the candidate occlusion image is.

In this embodiment, the visual security of the occlusion image is determined through two dimensions, that is, the repairability and the occlusion ratio, of the occlusion image, and the data availability of the occlusion image is measured by a target recognition effect of the occlusion image, thereby improving the accuracy of the visual security and the data availability of the occlusion image and providing a guarantee for the subsequent selection of the best target occlusion region based on the visual security and the data availability.

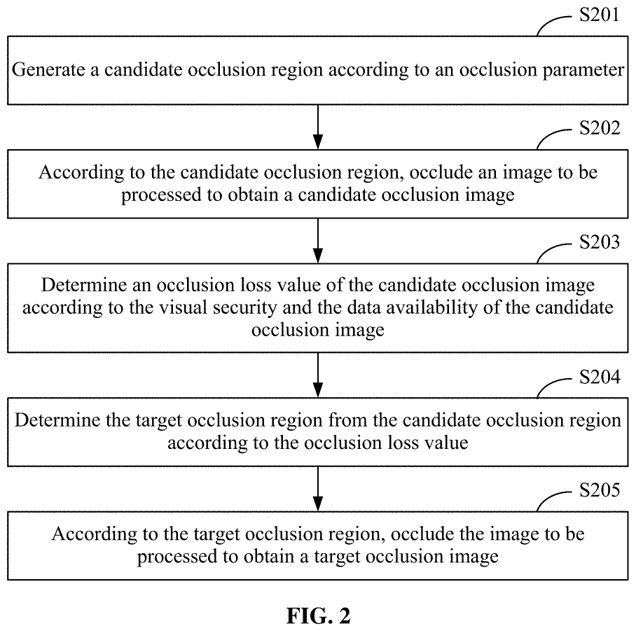

FIG. 2 is a flowchart of an image occlusion method according to an embodiment of the present disclosure. Based on the preceding embodiments, in this embodiment, how to determine the target occlusion region from the candidate occlusion regions according to the visual security and the data availability of the candidate occlusion images is further explained and described in detail. As shown in FIG. 2, the image occlusion method in this embodiment may include steps described below.

In S201, a candidate occlusion region is generated according to an occlusion parameter.

In S202, according to the candidate occlusion region, an image to be processed is occluded so as to obtain a candidate occlusion image.

In S203, an occlusion loss value of the candidate occlusion image is determined according to the visual security and the data availability of the candidate occlusion image.

The occlusion loss value may be an error of the occlusion image relative to the image to be processed in two dimensions, that is, the visual security and the data availability.

Optionally, in this embodiment, a difference between the visual security of the candidate occlusion image and the visual security of the image to be processed may be used as a first occlusion loss value, and a difference between the data availability of the candidate occlusion image and the data availability of the image to be processed may be used as a second occlusion loss value, and a final occlusion loss value of the candidate occlusion image is determined according to the first occlusion loss value and the second occlusion loss value.

Specifically, the occlusion loss value of the candidate occlusion image may be determined by formula (1) described below.

L=∥R(m*x)−y∥−α∥I(m*x)−I(x)∥−βP(m) (1)

L denotes the occlusion loss value of the candidate occlusion image; m denotes the candidate occlusion region; x denotes the image to be processed, and m*x denotes the candidate occlusion image; R(m*x) denotes a result of performing target recognition on the candidate occlusion image by a target recognition function R; y denotes a result of performing target recognition on the image to be processed; α and β denote a set of hyper-parameters for loss adjustment; I(m*x) denotes a determined repairability value of the candidate occlusion image by an image repair function I; I(x) denotes a determined repairability value of the image to be processed by the image repair function I; and P(m) denotes an occlusion ratio corresponding to the candidate occlusion region determined by a ratio calculation function P.

It is to be noted that, in this embodiment, the occlusion loss value corresponding to each candidate occlusion image may be determined according to the preceding method.

In S204, the target occlusion region is determined from the candidate occlusion region according to the occlusion loss value.

Optionally, in this embodiment, when the target occlusion region is determined from the candidate occlusion region according to the occlusion loss value, occlusion loss values of multiple candidate occlusion images may be compared, and the candidate occlusion region corresponding to the candidate occlusion image with a minimum occlusion loss value is selected as the target occlusion region.

In S205, according to the target occlusion region, the image to be processed is occluded so as to obtain a target occlusion image.

According to the solution of the embodiment of the present disclosure, candidate occlusion regions are randomly generated according to the occlusion parameter, occlusion loss values of the candidate occlusion images are calculated according to effects after the image to be processed is occluded by the candidate occlusion regions, that is, the visual security and the data availability, the candidate occlusion region corresponding to the minimum occlusion loss value is selected as the target occlusion region, and the image to be processed is occluded based on the target occlusion region, so as to obtain the target occlusion image. In the solution of this embodiment, the occlusion loss value is optimized continuously so as to search for the target occlusion region corresponding to the target occlusion image with high visual security and high data availability, thereby greatly improving the accuracy of determining the target occlusion region.

Optionally, in the embodiment of the present disclosure, a preferred manner of generating the candidate occlusion region according to the occlusion parameter may be: generating an initial occlusion region according to the occlusion parameter; and according to contribution of the initial occlusion region in a target recognition process, adjusting the initial occlusion region to obtain the candidate occlusion region. In a process of performing target recognition on the image, different regions in the image have different contributions to the target recognition. For example, in a process of performing face recognition on the face image, the facial features region has a higher degree of contribution to the face recognition than the background region. The contribution of the initial occlusion region in the target recognition process may refer to the contribution of a region in the image to be processed occluded by the initial occlusion region in the target recognition process of the image to be processed. Optionally, a method for determining the contribution of the initial occlusion region in the target recognition process may be as follows: first determining a position in the image to be processed occluded by the initial occlusion region (such as background, hair, eyes, nose or mouth), and then based on a contribution analysis algorithm (such as an error backpropagation (EBP) algorithm) or a contribution analysis model, analyzing the contribution of the occluded position in the image to be processed in the target recognition process of the image to be processed.

Specifically, in this embodiment, after one occlusion region (that is, the initial occlusion region) is generated by an occlusion generation algorithm or an occlusion generation model based the occlusion parameter, each position region with contribution greater than a contribution threshold needs to be removed from the initial occlusion region in conjunction with the contribution of each position region in the initial occlusion region in the target recognition process, so as to obtain one candidate occlusion region. In this solution, in the process of randomly generating the initial occlusion region based on the occlusion parameter, the contribution of the occlusion region in the target recognition process is introduced so that the generated candidate occlusion region does not contain the region with high contribution to the target recognition process as much as possible. Therefore, it is ensured that the occluded image based on the candidate occlusion region does not affect the target recognition effect as much as possible, that is, the occluded image still has relatively high data availability.

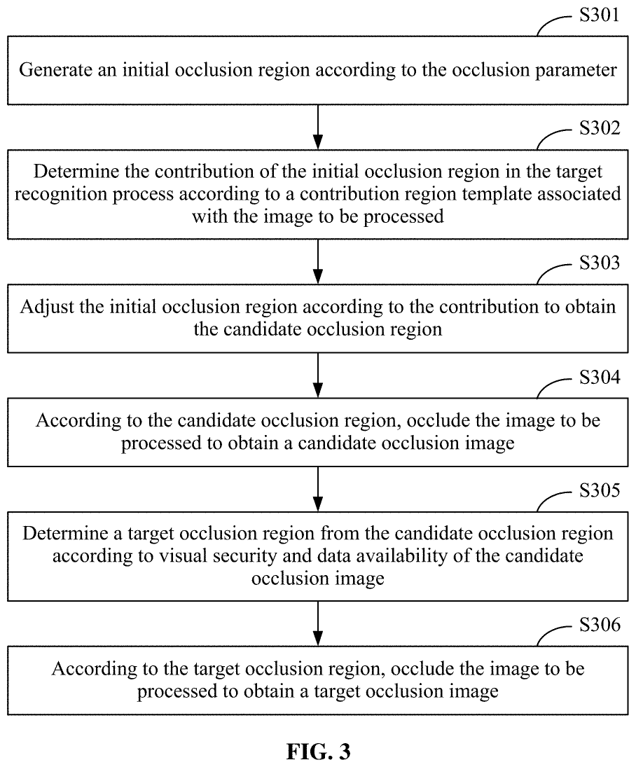

FIG. 3 is a flowchart of an image occlusion method according to an embodiment of the present disclosure. Based on the preceding embodiments, in the embodiment of the present disclosure, how to adjust the initial occlusion region according to the contribution of the initial occlusion region in the target recognition process is further explained and described in detail. As shown in FIG. 3, the image occlusion method in this embodiment may include steps described below.

In S301, an initial occlusion region is generated according to the occlusion parameter.

In S302, the contribution of the initial occlusion region in the target recognition process is determined according to a contribution region template associated with the image to be processed.

The contribution region template may be a template representing the contribution of each region in a certain type of image (such as the face image) to the target recognition process.

Optionally, in this embodiment, for various types of images, based on a large number of sample images of this type, a contribution region template associated with an image of the type may be generated. A specific generation process is as follows: according to contribution of each region of a sample image of a same type to target recognition, a contribution region template associated with an image of the type is generated.

Specifically, a target alignment process may be performed on multiple sample images of the same type, and then based on the contribution analysis algorithm (such as the EBP algorithm) or the contribution analysis model, the contribution of each region in each sample image to the target recognition after target alignment is analyzed. Since different images of the same type have a relatively high degree of overlap to regions with relatively high recognition contribution after the target alignment, in this embodiment, contributions of regions of the sample images may be integrated (for example, solving an average) as contributions corresponding to position regions in the images of this type, and then based on the contribution corresponding to each position region in the image of this type, the contribution region template associated with the image of this type is generated. In this embodiment, based on contributions of different regions in a large number of images of the same type to the target recognition, statistics of the contribution region template shared by the images of this type are performed, thereby improving the accuracy of determining the contribution region template of the images of this type.

Optionally, in this embodiment, a method for determining the contribution of the initial occlusion region in the target recognition process according to the contribution region template associated with the image to be processed may be as follows: mapping the initial occlusion region to the contribution region template associated with a type of the image to be processed. Since the contributions of different position regions in the target recognition process are marked in the contribution region template, the contribution of each position region in the initial occlusion region in the target recognition process is determined based on the contributions corresponding to different position regions marked in the contribution region template.

In S303, the initial occlusion region is adjusted according to the contribution so as to obtain the candidate occlusion region.

Specifically, according to the contributions of the position regions in the initial occlusion region in the target recognition process, each position region with contribution greater than the contribution threshold is removed from the initial occlusion region so as to obtain the candidate occlusion region.

In S304, according to the candidate occlusion region, the image to be processed is occluded so as to obtain a candidate occlusion image.

In S305, a target occlusion region is determined from the candidate occlusion region according to visual security and data availability of the candidate occlusion image.

In S306, according to the target occlusion region, the image to be processed is occluded so as to obtain a target occlusion image.

In the solution of the embodiment of the present disclosure, after the initial occlusion region is randomly generated according to the occlusion parameter, contribution of the initial occlusion region in a template recognition process is determined according to the contribution region template associated with the image to be processed, the initial occlusion region is adjusted in conjunction with the contribution so as to obtain the candidate occlusion region, the target occlusion region is determined from the candidate occlusion region according to the effect after the image to be processed is occluded by the candidate occlusion region, that is, the visual security and the data availability, and the image to be processed is occluded based on the target occlusion region so as to obtain the target occlusion image. In this solution, the contribution region template for each type of image is generated in advance, and when the initial occlusion region is adjusted subsequently, the contribution corresponding to the initial occlusion region is determined by directly using the contribution region template of the image of the type to which the image to be processed belongs, and contribution analysis through the contribution analysis algorithm (such as the EBP algorithm) or the contribution analysis model does not need to be performed for the initial occlusion region generated each time, thereby greatly improving the efficiency of determining the contribution.

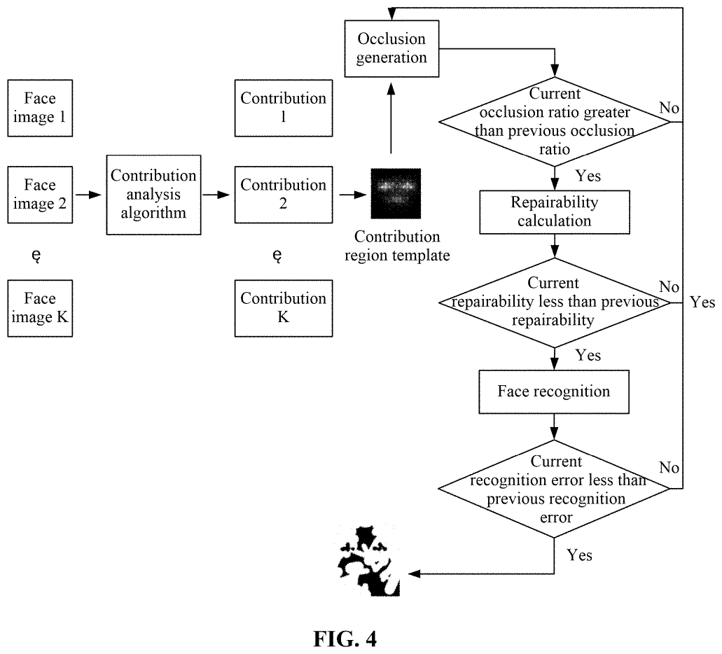

By way of example, FIG. 4 is a schematic diagram of a principle for determining a target occlusion region. As shown in FIG. 4, based on the contribution analysis algorithm (that is, the EBP algorithm), region contribution analysis of a face recognition process is performed on K sample face images in advance, respectively, contribution corresponding to each region of each sample face image is obtained (that is, contribution 1 to contribution K), contributions corresponding to regions of the K sample face images are integrated according to formula (2) described below, and the contribution region template xfr associated with the face images is obtained. As shown in FIG. 4B, in the contribution region template, a white region (that is, a region with a contribution value approaching 1) represents high contribution, and a black region (that is, a region with contribution approaching 0) represents low contribution.

$$xfr = \frac{1}{K} {\sum }_{i = 1}^{K} e ( {x}_{i} ) \qquad ( 2 )$$

xfr denotes the contribution region template associated with the face image; K denotes a total number of sample face images; xᵢ denotes the i-th face image; and e(xᵢ) denotes contribution of each region in the i-th face image to template recognition.

When the face image needs to be occluded, the contribution region template xfr may be obtained, and the initial occlusion region randomly generated based on the occlusion parameter is adjusted by formula (3) described below so as to obtain one candidate occlusion region.

m=G(v,l,b,a)+binaryzation(xfr,threshold) (3)

m denotes the candidate occlusion region; G(v,l,b,a) denotes the initial occlusion region randomly generated based on the occlusion parameter; binarization ( ) denotes a binarization function, xfr denotes the contribution region template associated with the face image, and threshold denotes a threshold.

An occlusion ratio of the currently generated candidate occlusion region is compared with an occlusion ratio of the previously generated candidate occlusion region. If the occlusion ratio of the currently generated candidate occlusion region is less than or equal to the occlusion ratio of the previously generated candidate occlusion region, the process returns back to the step of generating the candidate occlusion region so that the next candidate occlusion region is regenerated; otherwise, based on the image repair function I, the repairability of the candidate occlusion image occluded by the current candidate occlusion region is determined, and whether the repairability of the current candidate occlusion image is less than the repairability of the previous candidate occlusion image is analyzed, where if not, the process returns back to the step of generating the candidate occlusion region so that the next candidate occlusion region is regenerated; otherwise, based on the face recognition algorithm, face recognition is performed on the current candidate occlusion image, and whether a face recognition error of the current candidate occlusion image is less than a face recognition error of the previous candidate occlusion image is analyzed, where if so, the currently generated candidate occlusion region is used as the target occlusion region; otherwise, the process returns back to the step of generating the candidate occlusion region so that the next candidate occlusion region is regenerated.

It is to be noted that, in this embodiment, starting from the candidate occlusion region generated for the second time, each time a candidate occlusion region is generated, the preceding determination process is performed until the target occlusion region is determined.

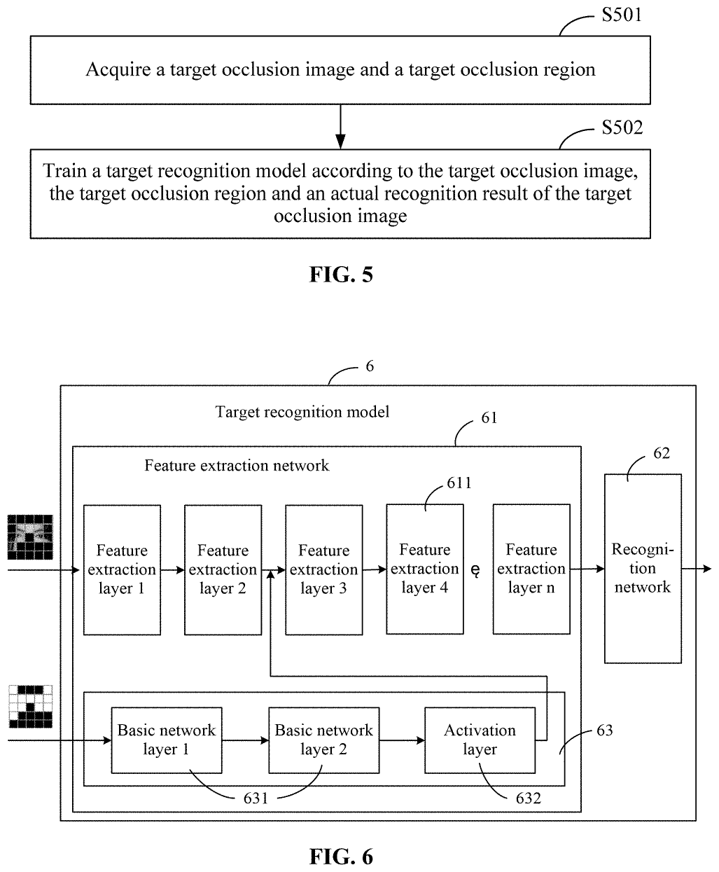

FIG. 5 is a flowchart of a model training method according to an embodiment of the present disclosure. The embodiment of the present disclosure is applicable to the case of performing model training based on an occlusion image. It is especially applicable to the case of performing model training based on the occlusion image generated in the preceding embodiments. The method may be performed by a model training apparatus. The apparatus may be implemented by means of software and/or hardware. As shown in FIG. 5, the model training method provided in this embodiment may include steps described below.

In S501, a target occlusion image and a target occlusion region are acquired.

The target occlusion image and the target occlusion region involved in this embodiment are obtained by using the image occlusion method described in any of the preceding embodiments of the present disclosure. The target occlusion region in this embodiment is an occlusion region used for forming the target occlusion image, that is, an un-occluded image is processed based on the target occlusion region so as to obtain the target occlusion image.

Optionally, in this step, the solution introduced in the preceding embodiments is executed so as to acquire the target occlusion image and the target occlusion region. The target occlusion image and the target occlusion region that are generated in advance according to the solution introduced in the preceding embodiments may also be directly acquired from an image library.

It is to be noted that, since an object of acquiring the target occlusion image in this embodiment is to train a model, the number of acquired target occlusion images and the number of corresponding target occlusion regions are preferably multiple.

In S502, a target recognition model is trained according to the target occlusion image, the target occlusion region and an actual recognition result of the target occlusion image.

Optionally, in this embodiment, the target occlusion image and the corresponding target occlusion region may be inputted into the target recognition model to be trained, so as to obtain a prediction recognition result corresponding to the target occlusion image predicted by the target recognition model based on the target occlusion image and the target occlusion region, the actual recognition result of the target occlusion image is used as supervision data, a training loss is determined in conjunction with the supervision data and the prediction recognition result, and the target recognition model is trained based on the training loss.

It is to be noted that, in this embodiment, the target recognition model needs to be iteratively trained for multiple times based on the preceding method through multiple groups of target occlusion images, target occlusion regions and actual recognition results of the target occlusion images until a preset training stop condition is reached, and then adjustment of a model parameter of the target recognition model stops so as to obtain the trained target recognition model. The training stop condition may include conditions below. The number of times of training reaches a preset number, or the training loss converges.

According to the solution of the embodiment of the present disclosure, the target occlusion image and the target occlusion region generated in conjunction with the visual security and the data availability are acquired, and the target recognition model is trained based on the target occlusion image, the target occlusion region and the actual recognition result corresponding to the target occlusion image. Since the images for model training in this embodiment are generated based on the visual security and the data availability, during a model training process, the leakage of sensitive image information can be avoided, and the accuracy of training results can be ensured. In addition, in this embodiment, when the target recognition model is trained, the occlusion region used for generating the occlusion image is also combined so that the model can perform target recognition more accurately.

Optionally, as shown in FIG. 6, in this embodiment, the target recognition model 6 to be trained includes a feature extraction network 61 and a recognition network 62; where a Feature Select Module (FSM) 63 is embedded in at least one feature extraction layer 611 of the feature extraction network 61; the FSM 63 includes at least one basic network layer 631 and an activation layer 632; and a number of basic network layers 631 is determined according to a position of the at least one feature extraction layer 611 in which the FSM 63 is embedded in the feature extraction network 61.

The target recognition model 6 includes a backbone network, that is, the feature extraction network 61 and the recognition network 62; where the feature extraction network 61 is used for extracting an image feature of an inputted image to be recognized (such as the target occlusion image) and transmitting an extraction result to the recognition network 62, and the recognition network 62 is used for performing target recognition based on a received image feature extraction result and outputting a recognition result. The feature extraction network 61 may include multiple (that is, n) feature extraction layers 611 connected end to end. For example, if a target recognition network is a resnet34 network, the feature extraction network 61 includes conv1-conv5_x; and the recognition network 62 is a pooling layer (avg_pool) and a fully connected layer (fc).

In this embodiment, among the multiple feature extraction layers 611, the FSM 63 is embedded in at least one feature extraction layer 611. FIG. 6 shows that one FSM 63 is embedded in a feature extraction layer 2, that is, after the feature extraction layer 2. An input of the FSM 63 is the target occlusion region corresponding to the target occlusion image and mainly used for providing additional information (such as a feature weight of each feature point) for the backbone network (that is, the feature extraction layer in which the FSM 63 is embedded) of the target recognition model according to an occlusion position and an occlusion shape in the target occlusion region. In this manner, the feature extraction layer 611 performs weighting processing on the feature (that is, an original feature map) extracted by the feature extraction layer 611 based on the feature weight provided by the FSM 63 as an actual output of the feature extraction layer 611.

Specifically, the FSM 63 includes at least one basic network layer 631 and the activation layer 632. The basic network layer 631 is formed by a convolutional layer with a preset stride (for example, 2 strides) activated by a linear rectification function (relu). The number of basic network layers 631 is determined according to the position of the feature extraction layer 611 in which the FSM 63 is embedded in the feature extraction network 61, that is, the feature extraction layer 611 in which the FSM 63 is embedded belongs to the i-th feature extraction layer of the feature extraction network 61, and the number of basic network layers 631 included in the FSM 63 is i.

Optionally, a possible implementation manner of the FSM 63 providing the feature weight for the feature extraction layer is as follows: providing, by the FSM, a corresponding weight value for each feature point corresponding to the occlusion image, for example, the feature weight of the occlusion region is low and the feature weight of the un-occluded region is high, so as to reduce the influence of information filled by the feature extraction network for the occlusion region on the target recognition result; another possible implementation manner is as follows: the FSM further includes an occlusion localization network, which filters out the weight value corresponding to the feature point of the un-occluded region, so that when weight is added to the feature extracted by the feature extraction layer, the weight is added to only the feature corresponding to the occlusion region, thereby not affecting the feature extraction result of the un-occluded region.

Optionally, the number of FSMs 63 embedded in the feature extraction network 61 of the target recognition network 6 and embedded points may be adjusted according to actual requirements, which is not limited. For example, the optimal number of embeddings and the optimal embedding positions may be selected through extensive experiments.

It is to be noted that when the feature extraction network performs feature extraction on the occlusion image, the un-occluded region is filled with information by means of convolution. However, the filled information may be detrimental to the accuracy of the recognition result. To solve this problem, in this embodiment, the FSM is embedded in the feature extraction network, so as to provide the feature extraction network with weight information of feature points based on the position and shape of the occlusion region through the FSM, so as to reduce the influence of the information filled in the occlusion region by the feature extraction network on the target recognition result, thereby improving the accuracy of the target recognition result.

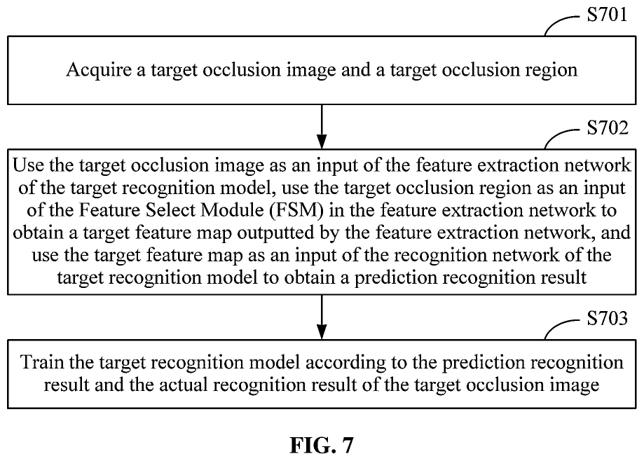

FIG. 7 is a flowchart of a model training method according to an embodiment of the present disclosure. Based on the preceding embodiments, in the embodiment of the present disclosure, how to train the target recognition model according to the target occlusion image, the target occlusion region and the actual recognition result of the target occlusion image is explained and described in detail. As shown in FIG. 7, the model training method provided in this embodiment may include steps described below.

In S701, a target occlusion image and a target occlusion region are acquired.

The target occlusion image and the target occlusion region are obtained by using the image occlusion method described in any of the preceding embodiments of the present disclosure.

In S702, the target occlusion image is used as an input of the feature extraction network of the target recognition model, the target occlusion region is used as an input of the FSM in the feature extraction network so as to obtain a target feature map outputted by the feature extraction network, and the target feature map is used as an input of the recognition network of the target recognition model so as to obtain a prediction recognition result.

The target feature map is a final result obtained after the feature extraction network performs feature extraction on the target occlusion image. The prediction recognition result is a predicted recognition result after the target recognition model performs face recognition on the target occlusion image.

Optionally, in this embodiment, the target occlusion image may be used as the input of the feature extraction network (specifically, the first feature extraction layer of the feature extraction network) of the target recognition model, the target occlusion region may be used as the input of each FSM embedded in the feature extraction network, and the feature extraction network and the FSM are executed so that the feature extraction network performs weighting processing on the extracted feature based on the feature weight provided by the FSM and obtains a final feature extraction result, that is, the target feature map; and the target feature map is inputted to the recognition network of the target recognition model so that the recognition network performs face recognition based on the target feature map to obtain the prediction recognition result.

Optionally, in a process of the feature extraction network outputting the target feature map, that is, in a process of performing feature extraction through each feature extraction layer of the feature extraction network, in the case where the FSM is embedded in the feature extraction layer, a feature weight is determined by the FSM, weighting processing is performed on an original feature map extracted by the feature extraction layer based on the feature weight so as to obtain a weighted feature map, and the weighted feature map is used as an input of a next network layer. In the case where the FSM is not embedded in the feature extraction layer, the feature extraction layer directly uses the extracted original feature map as the input of the next network layer.

By way of example, as shown in FIG. 6, the target occlusion image is inputted into a feature extraction layer 1 of the feature extraction network 61 of the target recognition model 6. Since the FSM 63 is not embedded in the feature extraction layer 1, the feature extraction layer 1 performs feature extraction on the inputted target occlusion image, the obtained original feature map 1 is directly inputted into the feature extraction layer 2, the FSM 63 is embedded in the feature extraction layer 2, the FSM 63 determines the feature weight based on the inputted target occlusion region (the feature weight may be the feature weight corresponding to feature points of all regions in the target occlusion image, or the feature weight corresponding to feature points of the occlusion region in the target occlusion image), the feature weight is provided to the feature extraction layer 2, the feature extraction layer 2 performs feature weighting on an extracted original feature map 2 based on the feature weight to obtain the weighted feature map, and the weighted feature map is inputted into a feature extraction layer 3; the FSM 63 is not embedded in the feature extraction layer 3, so the feature extraction layer 3 performs further feature extraction on the weighted feature map to obtain an original feature map 3, and the original feature map 3 is transmitted to a feature extraction layer 4, . . . , and so on. In this manner, an original feature map n outputted by a feature extraction layer n is used as the feature extraction result of the feature extraction network 61, that is, the target feature map.

In S703, the target recognition model is trained according to the prediction recognition result and the actual recognition result of the target occlusion image.

Optionally, in this embodiment, the training loss may be calculated according to the prediction recognition result and the actual recognition result of the target occlusion image, and the target recognition model is trained based on the training loss.

According to the solution of the embodiment of the present disclosure, the target occlusion image and the target occlusion region generated in conjunction with the visual security and the data availability are acquired, the target occlusion image and the target occlusion region are used as the input of the feature extraction network and the input of the FSM, respectively, the target feature map outputted by the feature extraction network is obtained and inputted into the recognition network so as to obtain the prediction recognition result, and the training loss is calculated in conjunction with the actual recognition result of the target occlusion image so as to train the target recognition model. This solution provides a preferable manner of how to train a target model through the desensitized occlusion image, and the FSM is embedded in the target model and can assist the backbone network of the target model to perform target recognition more accurately. While a model training effect is ensured, a recognition effect of the trained target recognition model is further improved.

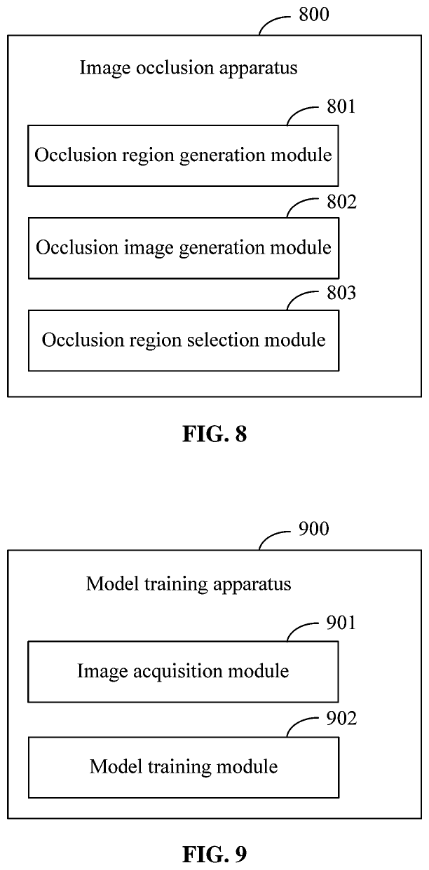

FIG. 8 is a structural diagram of an image occlusion apparatus according to an embodiment of the present disclosure. The embodiment of the present disclosure is applicable to the case of performing regional occlusion on an image. It is especially applicable to the case of performing regional occlusion on an image containing sensitive information (such as a face image). The apparatus may be implemented by software and/or hardware, and the apparatus can perform the image occlusion method according to any embodiment of the present disclosure. As shown in FIG. 8, an image occlusion apparatus 800 includes an occlusion region generation module 801, an occlusion image generation module 802, and an occlusion region selection module 803.

The occlusion region generation module 801 is configured to generate a candidate occlusion region according to an occlusion parameter.

The occlusion image generation module 802 is configured to, according to the candidate occlusion region, occlude an image to be processed to obtain a candidate occlusion image.

The occlusion region selection module 803 is configured to determine a target occlusion region from the candidate occlusion region according to visual security and data availability of the candidate occlusion image.

The occlusion image generation module 802 is further configured to, according to the target occlusion region, occlude the image to be processed to obtain a target occlusion image.

According to the solution of the embodiment of the present disclosure, candidate occlusion regions are randomly generated according to the occlusion parameter, the target occlusion region is determined from the candidate occlusion regions according to effects after the image to be processed is occluded by the candidate occlusion regions, that is, the visual security and the data availability, and then the image to be processed is occluded based on the target occlusion region so as to obtain the target occlusion image. In the solution in this embodiment, regional occlusion is performed on the image from the perspective of the visual security and the data availability. Compared with the related art in which specific regions (such as human eyes, nose or mouth) are occluded, in this embodiment, not only is the availability of the occluded image taken into account, but also a desensitization effect of sensitive information in the original image is greatly improved and the flexibility of the occluded region is improved. A new solution for the occlusion of sensitive information in the image is provided.

Further, the occlusion region selection module 803 is specifically configured to perform steps described below.

An occlusion loss value of the candidate occlusion image is determined according to the visual security and the data availability of the candidate occlusion image.

The target occlusion region is determined from the candidate occlusion region according to the occlusion loss value.

Further, the apparatus 800 further includes a security determination module and an availability determination module.

The security determination module is configured to determine repairability and an occlusion ratio of the candidate occlusion image according to the candidate occlusion image and the image to be processed and determine the visual security of the candidate occlusion image according to the repairability and the occlusion ratio.

The availability determination module is configured to determine the data availability of the candidate occlusion image according to a target recognition result of the candidate occlusion image and a target recognition result of the image to be processed.

Further, the occlusion region generation module 801 includes an occlusion region generation unit and an occlusion region adjustment unit.

The occlusion region generation unit is configured to generate an initial occlusion region according to the occlusion parameter.

The occlusion region adjustment unit is configured to, according to contribution of the initial occlusion region in a target recognition process, adjust the initial occlusion region to obtain the candidate occlusion region.

Further, the occlusion region adjustment unit is specifically configured to perform steps described below.

The contribution of the initial occlusion region in the target recognition process is determined according to a contribution region template associated with the image to be processed.

The initial occlusion region is adjusted according to the contribution.

Further, the apparatus 800 further includes a region template generation module.

The region template generation module is configured to, according to contribution of each region of a sample image of a same type to target recognition, generate a contribution region template associated with an image of the type.

FIG. 9 is a structural diagram of a model training apparatus according to an embodiment of the present disclosure. The embodiment of the present disclosure is applicable to the case of performing model training based on an occlusion image. It is especially applicable to the case of performing model training based on the occlusion image generated in the preceding embodiments. The apparatus may be implemented by software and/or hardware, and the apparatus can implement the model training method according to any embodiment of the present disclosure. As shown in FIG. 9, a model training apparatus 900 includes an image acquisition module 901 and a model training module 902.

The image acquisition module 901 is configured to acquire a target occlusion image and a target occlusion region; where the target occlusion image and the target occlusion region are obtained by using the image occlusion apparatus according to any embodiment of the present disclosure.

The model training module 902 is configured to train a target recognition model according to the target occlusion image, the target occlusion region and an actual recognition result of the target occlusion image.

According to the solution of the embodiment of the present disclosure, the target occlusion image and the target occlusion region generated in conjunction with the visual security and the data availability are acquired, and the target recognition model is trained based on the target occlusion image, the target occlusion region and the actual recognition result corresponding to the target occlusion image. Since the images for model training in this embodiment are generated based on the visual security and the data availability, during a model training process, the leakage of sensitive image information can be avoided, and the accuracy of training results can be ensured. In addition, in this embodiment, when the target recognition model is trained, the occlusion region used for generating the occlusion image is also combined so that the model can perform target recognition more accurately.

Further, the target recognition model includes a feature extraction network and a recognition network; where an FSM is embedded in at least one feature extraction layer of the feature extraction network; the FSM includes at least one basic network layer and an activation layer; and a number of basic network layers is determined according to a position of the feature extraction layer in which the FSM is embedded in the feature extraction network.

Further, the model training module 902 includes a model running unit and a model training unit.

The model running unit is configured to use the target occlusion image as an input of the feature extraction network of the target recognition model, use the target occlusion region as an input of the FSM in the feature extraction network to obtain a target feature map outputted by the feature extraction network, and use the target feature map as an input of the recognition network of the target recognition model to obtain a prediction recognition result.

The model training unit is configured to train the target recognition model according to the prediction recognition result and the actual recognition result of the target occlusion image.

Further, the model running unit is specifically configured to perform a step described below.

In a process of performing feature extraction through each of the at least one feature extraction layer of the feature extraction network, in the case where the FSM is embedded in the at least one feature extraction layer, a feature weight is determined by the FSM, weighting processing is performed on an original feature map extracted by the at least one feature extraction layer based on the feature weight so as to obtain a weighted feature map, and the weighted feature map is used as an input of a next network layer.

The preceding product may perform the method provided by any embodiment of the present disclosure, and has functional modules and beneficial effects corresponding to the performed method.

The acquisition, storage, application and the like of any sample image, any image to be processed and any target occlusion image involved in the technical solutions of the present disclosure are in compliance with relevant laws and regulations and do not violate the public order and good customs.

According to an embodiment of the present disclosure, the present disclosure further provides an electronic device, a readable storage medium and a computer program product.

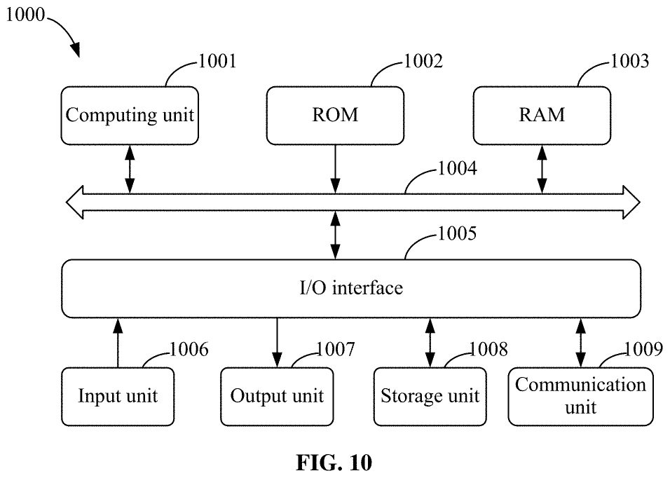

FIG. 10 is a block diagram of an exemplary electronic device 1000 that may be configured to implement the embodiments of the present disclosure. Electronic devices are intended to represent various forms of digital computers, for example, a laptop computer, a desktop computer, a worktable, a personal digital assistant, a server, a blade server, a mainframe computer or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein.

As shown in FIG. 10, the device 1000 includes a computing unit 1001. The computing unit 1001 may perform various types of appropriate operations and processing based on a computer program stored in a read-only memory (ROM) 1002 or a computer program loaded from a storage unit 1008 to a random-access memory (RAM) 1003. Various programs and data required for operations of the device 1000 may also be stored in the RAM 1003. The computing unit 1001, the ROM 1002 and the RAM 1003 are connected to each other through a bus 1004. An input/output (I/O) interface 1005 is also connected to the bus 1004.

Multiple components in the device 1000 are connected to the I/O interface 1005. The components include an input unit 1006 such as a keyboard and a mouse, an output unit 1007 such as various types of displays and speakers, the storage unit 1008 such as a magnetic disk and an optical disc, and a communication unit 1009 such as a network card, a modem and a wireless communication transceiver. The communication unit 1009 allows the device 1000 to exchange information/data with other devices over a computer network such as the Internet and/or various telecommunications networks.

The computing unit 1001 may be various general-purpose and/or special-purpose processing components having processing and computing capabilities. Examples of the computing unit 1001 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 1001 performs various methods and processing described above, such as the image occlusion method and/or model training method. For example, in some embodiments, the image occlusion method and/or model training method may be implemented as a computer software program tangibly contained in a machine-readable medium such as the storage unit 1008. In some embodiments, part or all of computer programs may be loaded and/or installed on the device 1000 via the ROM 1002 and/or the communication unit 1009. When the computer programs are loaded into the RAM 1003 and executed by the computing unit 1001, one or more steps of the preceding image occlusion method and/or model training method may be performed. Alternatively, in other embodiments, the computing unit 1001 may be configured, in any other suitable manner (for example, by means of firmware), to perform the image occlusion method and/or model training method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

Cloud computing refers to a technical system that accesses a shared elastic-and-scalable physical or virtual resource pool through a network, where resources may include servers, operating systems, networks, software, applications and storage devices and may be deployed and managed in an on-demand, self-service manner. Cloud computing can provide efficient and powerful data processing capabilities for artificial intelligence, the blockchain and other technical applications and model training.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

1. An image occlusion method, comprising:
generating a candidate occlusion region according to an occlusion parameter;
occluding, according to the candidate occlusion region, an image to be processed to obtain a candidate occlusion image;
determining a target occlusion region from the candidate occlusion region according to visual security and data availability of the candidate occlusion image; and
occluding, according to the target occlusion region, the image to be processed to obtain a target occlusion image.

2. The method of claim 1, wherein determining the target occlusion region from the candidate occlusion region according to the visual security and the data availability of the candidate occlusion image comprises:
determining an occlusion loss value of the candidate occlusion image according to the visual security and the data availability of the candidate occlusion image; and
determining the target occlusion region from the candidate occlusion region according to the occlusion loss value.

3. The method of claim 1, further comprising:
determining repairability and an occlusion ratio of the candidate occlusion image according to the candidate occlusion image and the image to be processed and determining the visual security of the candidate occlusion image according to the repairability and the occlusion ratio; and
determining the data availability of the candidate occlusion image according to a target recognition result of the candidate occlusion image and a target recognition result of the image to be processed.

4. The method of claim 2, further comprising:
determining repairability and an occlusion ratio of the candidate occlusion image according to the candidate occlusion image and the image to be processed and
determining the visual security of the candidate occlusion image according to the repairability and the occlusion ratio; and
determining the data availability of the candidate occlusion image according to a target recognition result of the candidate occlusion image and a target recognition result of the image to be processed.

5. The method of claim 1, wherein generating the candidate occlusion region according to the occlusion parameter comprises:
generating an initial occlusion region according to the occlusion parameter; and
adjusting, according to contribution of the initial occlusion region in a target recognition process, the initial occlusion region to obtain the candidate occlusion region.

6. The method of claim 5, wherein adjusting, according to the contribution of the initial occlusion region in the target recognition process, the initial occlusion region comprises:
determining the contribution of the initial occlusion region in the target recognition process according to a contribution region template associated with the image to be processed; and
adjusting the initial occlusion region according to the contribution.

7. The method of claim 6, further comprising:
generating a contribution region template associated with an image of the type according to contribution of each region of a sample image of a same type to target recognition.

8. A model training method, comprising:
acquiring a target occlusion image and a target occlusion region; wherein the target occlusion image and the target occlusion region are obtained by using the image occlusion method of claim 1; and
training a target recognition model according to the target occlusion image, the target occlusion region and an actual recognition result of the target occlusion image.

9. The method of claim 8, wherein
the target recognition model comprises a feature extraction network and a recognition network;
a Feature Select Module (FSM) is embedded in at least one feature extraction layer of the feature extraction network; and
the FSM comprises at least one basic network layer and an activation layer; and a number of basic network layers is determined according to a position of the at least one feature extraction layer in which the FSM is embedded in the feature extraction network.

10. The method of claim 9, wherein training the target recognition model according to the target occlusion image, the target occlusion region and the actual recognition result of the target occlusion image comprises:
using the target occlusion image as an input of the feature extraction network of the target recognition model, using the target occlusion region as an input of the FSM in the feature extraction network to obtain a target feature map outputted by the feature extraction network, and using the target feature map as an input of the recognition network of the target recognition model to obtain a prediction recognition result; and
training the target recognition model according to the prediction recognition result and the actual recognition result of the target occlusion image.

11. The method of claim 10, wherein in a process of the feature extraction network outputting the target feature map, the method further comprises:
in a process of performing feature extraction through each of the at least one feature extraction layer of the feature extraction network, in a case where the FSM is embedded in a current feature extraction layer of the at least one feature extraction layer, determining a feature weight by the FSM, performing weighting processing on an original feature map extracted by the current feature extraction layer based on the feature weight to obtain a weighted feature map, and using the weighted feature map as an input of a next feature extraction layer.

12. An electronic device, comprising:
at least one processor; and
a memory communicatively connected to the at least one processor,
wherein the memory stores instructions executable by the at least one processor, and the instructions are executed by the at least one processor to cause the at least one processor to perform:
generating a candidate occlusion region according to an occlusion parameter;
occluding, according to the candidate occlusion region, an image to be processed to obtain a candidate occlusion image;
determining a target occlusion region from the candidate occlusion region according to visual security and data availability of the candidate occlusion image; and
occluding, according to the target occlusion region, the image to be processed to obtain a target occlusion image.

13. The electronic device of claim 12, wherein at least one processor determines the target occlusion region from the candidate occlusion region according to the visual security and the data availability of the candidate occlusion image by:
determining an occlusion loss value of the candidate occlusion image according to the visual security and the data availability of the candidate occlusion image; and
determining the target occlusion region from the candidate occlusion region according to the occlusion loss value.

14. The electronic device of claim 12, wherein the at least one processor is further configured to perform:
determining repairability and an occlusion ratio of the candidate occlusion image according to the candidate occlusion image and the image to be processed and determining the visual security of the candidate occlusion image according to the repairability and the occlusion ratio; and
determining the data availability of the candidate occlusion image according to a target recognition result of the candidate occlusion image and a target recognition result of the image to be processed.

15. The electronic device of claim 14, wherein the at least one processor is further configured to perform:
determining repairability and an occlusion ratio of the candidate occlusion image according to the candidate occlusion image and the image to be processed and determining the visual security of the candidate occlusion image according to the repairability and the occlusion ratio; and
determining the data availability of the candidate occlusion image according to a target recognition result of the candidate occlusion image and a target recognition result of the image to be processed.

16. The electronic device of claim 12, wherein the at least one processor generates the candidate occlusion region according to the occlusion parameter by:
generating an initial occlusion region according to the occlusion parameter; and
adjusting, according to contribution of the initial occlusion region in a target recognition process, the initial occlusion region to obtain the candidate occlusion region.

17. The electronic device of claim 16, wherein the at least one processor adjusts, according to the contribution of the initial occlusion region in the target recognition process, the initial occlusion region by:
determining the contribution of the initial occlusion region in the target recognition process according to a contribution region template associated with the image to be processed; and
adjusting the initial occlusion region according to the contribution.

18. An electronic device, comprising:
at least one processor; and
a memory communicatively connected to the at least one processor,
wherein the memory stores instructions executable by the at least one processor, and the instructions are executed by the at least one processor to cause the at least one processor to perform the model training method of claim 8.

19. A non-transitory computer-readable storage medium storing computer instructions for causing a computer to perform the image occlusion method of claim 1.

20. A non-transitory computer-readable storage medium storing computer instructions for causing a computer to perform the model training method of claim 8.
